(19) United States
(12) Patent Application Publication
(10) Pub. No.: US 2024/0174260 A1
(43) Pub. Date: May 30, 2024

(54) METHOD AND SYSTEM FOR DETERMINING ITEMS OF INFORMATION REGARDING THE MOVEMENT OF A VEHICLE

(71) Applicants: Continental Autonomous Mobility Germany GmbH, Ingolstadt (DE); Volkswagen AG, Wolfsburg (DE)

(72) Inventors: Dieter KRÖKEL, Nürnberg (DE); Stefan HEINRICH, Nürnberg (DE); Thomas Fechner, Nürnberg (DE); Heiko Gustav Kurz, Hannover (DE)

(21) Appl. No.: 18/551,589

(22) PCT Filed: Mar. 18, 2022
(86) PCT No.: PCT/EP2022/057203

§ 371 Date: Sep. 20, 2023

(30) Foreign Application Priority Data
Mar. 22, 2021 (DE) 10 2021 106 988.2

(51) Int. Cl. B60W 60/00

(52) U.S. Cl. CPC B60W 60/001; B60W 2420/403

(57) ABSTRACT

A method for determining information about the ego-motion of a vehicle, wherein the vehicle comprises a stereo camera system with at least two cameras for capturing stereo images of the area surrounding the vehicle and an artificial neural network for processing the image information provided by the stereo camera system, wherein the stereo camera system captures image sequences which contain a plurality of image information at different points in time by means of the at least two cameras during the movement of the vehicle, wherein the artificial neural network receives the image information and, based thereon, generates stereo images with distance information, and the artificial neural network provides information regarding the ego-motion of the vehicle at an output interface on the basis of the image information of the stereo camera system.

### FIELD

The invention relates to a method and a system for determining information regarding the ego-motion of a vehicle as well as to a vehicle having a system of this type.

### BACKGROUND

For autonomous driving functions, it is necessary to be able to determine the position of the vehicle and/or the movement of the vehicle in space as accurately as possible. It is known that vehicles have an odometry unit for this purpose, which provides information regarding the movement of the vehicle in space. For this purpose, the odometry unit receives measurement information from various sensors, for example wheel rotation sensors, yaw rate sensors, steering angle sensors and/or GPS sensors, and uses this to determine information regarding the movement of the vehicle in space and the resulting position of the vehicle.

The problem here is that known odometry units have a relatively poor resolution so that changes in the vehicle position can only be poorly detected, which is particularly disadvantageous for autonomous driving functions.

Based on this, an object of the present disclosure is to provide a method for determining information regarding the ego-motion of a vehicle that provides reliable and highly accurate information about the ego-motion of the vehicle.

A system for determining information about the ego-motion of a vehicle is also described, and a vehicle comprising such a system is also described.

According to a first aspect, the present disclosure relates to a method for determining information about the ego-motion of a vehicle. The vehicle comprises a stereo camera system including at least two cameras for capturing stereo images of the area surrounding the vehicle, and an artificial neural network for processing the image information provided by the stereo camera system. By means of the at least two cameras, the stereo camera system captures image sequences that contain a plurality of image information at different points in time during the movement of the vehicle. In particular, an image pair comprising image information from a first and a second camera is captured at successive points in time in each case. The image pairs that are sequential in time form the image sequences.

The artificial neural network receives the image information and generates stereo images with distance information based on said image information. In particular, the stereo images include color information for each pixel (e.g. RGB values or gray values) and pixel-related distance information. The distance information here indicates how far the area of the scene imaged by the pixel is spaced apart from the vehicle or from the stereo camera system.

On the basis of the image information of the stereo camera system, the artificial neural network provides information regarding the ego-motion of the vehicle at an output interface. In other words, the neural network thus estimates the ego-motion of the vehicle from the temporal change of the image information provided by the cameras, and this estimated ego-motion information is outputted in addition to the stereo images.

The technical advantage of the proposed method is that the ego-motion of the vehicle can be determined with a very high accuracy by assessing the image information of the cameras of the stereo camera system since a shift of the image information even by one or a few pixels can be converted into ego-motion information. Thus, the ego-motion determination by the proposed method is in particular much more accurate than the ego-motion determination by known odometry units. This method is also clearly superior to the optical flow using a mono camera because of the significantly better signal-to-noise ratio due to the nonlinear correlation of the artificial neural network.

According to an exemplary embodiment, the artificial neural network analyzes the temporal change of the image information in the image sequences and generates information regarding the ego-motion of the vehicle based on said temporal change of image information. In particular, a conclusion is made regarding the ego-motion on the basis of image shifts and/or image distortions caused by the changing capturing direction of the cameras. Due to the high resolution of image information and the typically large distances between the scene depicted in the image information and the vehicle, even very small changes in the vehicle position or vehicle orientation can be detected. This creates a very high accuracy with regard to the determination of the ego-motion information.

According to an exemplary embodiment, the information regarding the ego-motion of the vehicle comprises information about the translational motion of the vehicle along three axes of a Cartesian coordinate system. In particular, the ego-motion information is velocity information indicating at what velocity the vehicle moves in the direction of the respective axes. In other words, the ego-motion information is, for example, longitudinal, vertical, and lateral velocity information.

According to an exemplary embodiment, the information regarding the ego-motion of the vehicle comprises information about a rotational motion of the vehicle about the three axes of a Cartesian coordinate system. In particular, the ego-motion information is rotational velocity information or angular velocity information, indicating at what velocity the vehicle rotates about the respective axes. In other words, the ego-motion information comprises, for example, pitch, yaw, and roll velocity information.

According to an exemplary embodiment, the artificial neural network compensates for changes in calibration parameters of the stereo camera system. In particular, the artificial neural network uses a nonlinear correlation of image information to compensate for the calibration inaccuracies. Preferably, the artificial neural network is trained to detect and compensate for the calibration of the cameras of the stereo camera system from the detected disparity. For this purpose, the neural network is supplied during training with image sequences which are recorded from different viewing directions and are suitably labeled, i.e. disparity information and/or distance information is available for the individual pixels in each case. Preferably, the training data also comprises calibration information. This calibration information is uniquely assigned to the image information. Using this calibration information of the training data, the neural network can learn how stereo images change depending on the calibration of the cameras. Thus, the weight factors of the neural network can be selected so as to minimize the error between the detected disparity and the disparity specified by the training data, or the error between the distance information determined by the neural network and the distance information of the training data.

According to an exemplary embodiment, the cameras of the stereo camera system comprise inertial sensors that determine changes in motion of the cameras. For example, the inertial sensors can detect translational motions of the camera in three spatial directions of a Cartesian coordinate system and rotational motions about the three spatial axes of the Cartesian coordinate system. It is thus possible to detect absolute position or orientation changes of the respective camera and changes in the relative position or orientation of the two cameras to each other (i.e. extrinsic calibration parameters).

According to an exemplary embodiment, the calibration parameters of the stereo camera system are adjusted using information provided by the inertial sensors of the cameras of the stereo camera system. Via the inertial sensors of the cameras, the position or orientation changes of the cameras are detected preferably during the operation of the stereo camera system and calibration parameters of the stereo camera system are adjusted on this basis.

According to a further exemplary embodiment, information from the inertial sensors of the cameras is used to carry out initial training of the neural network. Preferably, the training data comprise inertial sensor information that replicates position or orientation changes of the cameras. This allows the neural network to be trained to detect and compensate for calibration inaccuracies.

According to an exemplary embodiment, further information provided by sensors is used to detect and compensate for calibration changes. For example, information provided by a temperature sensor can be used to compensate for temperature-dependent calibration changes.

According to an exemplary embodiment, the artificial neural network is a pre-trained neural network trained using training data in the form of stereo images of a scene and associated calibration parameters, the training data indicating how the stereo images change depending on modifications to the calibration parameters of the cameras of the stereo camera system. This allows the neural network to be trained to compensate for calibration inaccuracies or calibration deviations of the cameras.

According to an exemplary embodiment, the artificial neural network is post-trained on the basis calibration information generated from information from the inertial sensors of the cameras. As a result, the neural network can be adjusted to the calibration changes in an online training. Likewise, the inertial sensors of the cameras can be used to provide motion information of the cameras that is used for initial training of the neural network.

According to a further aspect, the present disclosure relates to a system for determining information about the ego-motion of a vehicle. The vehicle includes a stereo camera system comprising at least two cameras for capturing stereo images of the area surrounding the vehicle, and an artificial neural network for processing the image information provided by the stereo camera system. The stereo camera system is designed to capture, by means of the at least two cameras, image sequences containing a plurality of image information at different points in time during the movement of the vehicle. The artificial neural network is designed to receive the image information and generates stereo images with distance information based on said image information. The artificial neural network comprises an output interface at which information regarding the ego-motion of the vehicle is provided, which is calculated on the basis of the image sequences by the artificial neural network.

According to an exemplary embodiment, the artificial neural network is configured to analyze the change in the image information over time in the image sequences and to generate information regarding the ego-motion of the vehicle based on said change in the image information. In particular, a conclusion is made regarding the ego-motion of the vehicle on the basis of image shifts and/or image distortions that result from the changing capturing direction of the cameras. Due to the high resolution of image information and the typically large distances between the scene depicted in the image information and the vehicle, even very small changes in the vehicle position or vehicle orientation can be detected. This creates a very high accuracy with regard to the determination of the ego-motion information.

According to an exemplary embodiment, the artificial neural network is configured to provide information about the translational motion of the vehicle along three axes of a Cartesian coordinate system and information about a rotational motion of the vehicle about the three axes of the Cartesian coordinate system at the output interface. In particular, the information is velocity information indicating the velocity at which the vehicle moves in the direction of the respective axes or the rotational velocity at which the vehicle rotates about one or more of these axes. In other words, the ego-motion information is, for example, longitudinal, vertical, and lateral velocity information and/or pitch, yaw, and roll velocity information.

According to a final aspect, the present disclosure relates to a vehicle comprising an above mentioned system according to any one of the exemplary embodiments.

The expressions “approximately”, “substantially” or “about” mean in the sense of the present disclosure deviations from the respective exact value by +/−10%, preferably by +/−5% and/or deviations in the form of changes that are insignificant for the function.

Further developments, advantages and possible uses of the present disclosure also result from the following description of exemplary embodiments and from the drawings. In this connection, all the features described and/or illustrated are in principle the subject matter of the present disclosure, either individually or in any combination, irrespective of their summary in the claims or their back-reference. The content of the claims is also made a part of the description.

### BRIEF DESCRIPTION OF THE DRAWINGS

The invention will be explained in more detail below with reference to the drawings by means of exemplary embodiments. In the drawings:

FIG. 1 shows, by way of example, a schematic representation of a stereo camera system coupled to an artificial neural network for providing stereo images and information about the ego-motion of a vehicle;

FIG. 2 shows, by way of example and diagram, a schematic representation of a stereo camera system that uses information from the inertial sensors to train the neural network; and

FIG. 3 shows, by way of example, a schematic representation of the method steps for determining information about the ego-motion of the vehicle.

### DETAILED DESCRIPTION

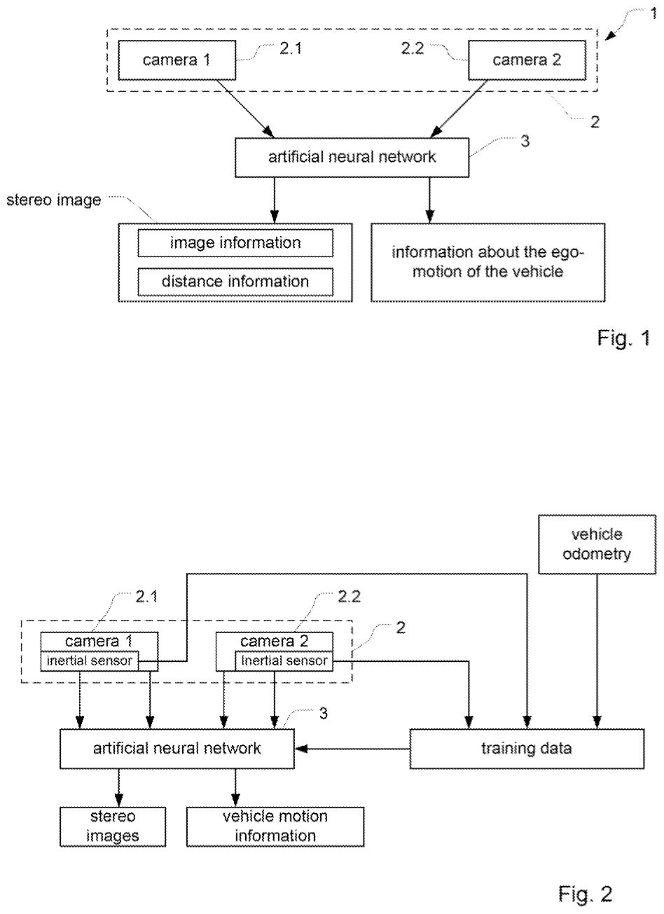

FIG. 1 shows, by way of example, a schematic block diagram of a system 1 for determining information regarding the ego-motion of a vehicle.

The system has a stereo camera system 2 comprising at least two cameras 2.1, 2.2. In this context, the stereo camera system 2 records image information of the vehicle environment, in particular of an area in front of the vehicle in the direction of forward travel, as image pairs, i.e. one image is recorded with the first camera 2.1 and one image is recorded with a second camera 2.2 at the same points in time, which show the same scene but from different viewing directions since the cameras 2.1, 2.2 are arranged at different positions at the vehicle.

For example, the cameras 2.1, 2.2 can be installed in the headlights of the vehicle. Alternatively, the cameras 2.1, 2.2 can also be integrated into the front area of the vehicle or into the windshield. The cameras 2.1, 2.2 preferably have a distance greater than 0.5 m from each other in order to achieve a high distance resolution by means of a base width as large as possible.

The cameras 2.1, 2.2 record multiple image pairs sequentially in time, i.e. at different points in time, so that image sequences are created. Due to the vehicle movement, the image information changes since the image pairs are recorded at different vehicle positions in space.

The system also comprises an artificial neural network 3 which is pre-trained by initial training and which is configured to process the image information provided by the stereo camera system 2. The artificial neural network 3 can be, for example, a deep neural network, in particular a convolutional neural network (CNN).

The neural network 3 receives the image information provided by the stereo camera system 2 and estimates disparity information regarding this image information. The disparity information indicates the lateral offset between the individual pixels of the image information of an image pair. This lateral offset is a measure of the distance that the scene area represented by the pixel is spaced apart from the vehicle or from the stereo camera system 2. Thus, distance information indicating how far a scene area represented by a pixel is away from the vehicle or from the stereo camera system 2 can be obtained from the disparity information. As a result, the neural network 3 can provide stereo images that contain distance information about each pixel in addition to two-dimensional image information in the form of pixel-related color values.

The artificial neural network 3 is also configured to estimate the ego-motion of the vehicle on the basis of the image information provided by the cameras 2.1, 2.2. In the time-sequential image information of the image sequences, position changes of the pixels result due to the vehicle movement, i.e. an area of a scene appears, due to the vehicle movement, in a subsequent image of the image sequence at another position than in a preceding image of the image sequence. The neural network is trained to estimate information about the ego-motion of the vehicle, hereinafter also referred to as odometry data, on the basis of these position changes.

The neural network comprises an output interface at which the odometry data of the vehicle is outputted. In particular, information about the translational motion of the vehicle along three spatial axes of a Cartesian coordinate system is outputted. This is in particular velocity information, i.e. the longitudinal, vertical, and lateral velocity of the vehicle.

In addition, information about the rotational motion of the vehicle about the three spatial axes of the Cartesian coordinate system is preferably outputted. In particular, this is rotational speed information, i.e. the pitch, yaw and roll speed of the vehicle.

The high resolution of the image information results in a high resolution of the information about the ego-motion of the vehicle, which is in particular higher than the information provided by an odometry unit of the vehicle.

Preferably, the ego-motion information provided by the neural network 3 is used to modify the information provided by an odometry unit of the vehicle. In particular, by merging the ego-motion information provided by the neural network 3 and the information provided by the odometry unit, it is possible to create modified odometry information in order to allow for a more accurate position determination of the vehicle.

FIG. 2 shows an embodiment of a stereo camera system 2 in which the cameras 2.1, 2.2 have inertial sensors. The inertial sensors are configured to detect motion changes of the cameras and the vehicle. In particular, these changes can be translational motion changes along three axes of a Cartesian coordinate system and rotational motion changes about these three axes of the Cartesian coordinate system.

By means of the inertial sensors it is possible to detect the absolute change in motion of the camera 2.1, 2.2 and thus an absolute position change of this camera 2.1, 2.2. In addition, taking into account the information about the change in movement of both cameras 2.1, 2.2, it is also possible to determine a relative change in movement of the cameras 2.1, 2.2 with respect to each other or a change in the relative position of the cameras 2.1, 2.2 with respect to each other. Thus, the extrinsic parameters and calibration parameters of the cameras 2.1, 2.2 can be adjusted and thus the calculation of the stereo images or the distance information of the stereo images can be improved.

Preferably, the information of the inertial sensors or information derived therefrom is transmitted to the neural network 3 so that, depending on this information of the inertial sensors, the weighting factors of the neural network 3 can be adjusted. This allows the calculation of the stereo images by the neural network 3 to be adjusted to the changed camera positioning and associated calibration changes.

The neural network 3 is preferably designed to estimate disparity information and to compensate for calibration inaccuracies caused by a change in the extrinsic parameters of the stereo camera system 2. For this purpose, the neural network 3 is trained using training data in which the distance of all pixels to the stereo camera system is known, and the neural network 3 is optimized to detect the disparity.

Preferably, the neural network 3 here uses a nonlinear correlator to determine the disparity information. During the training of the neural network 3, i.e. during the initial training or an online training during the operation of the system or during breaks in operation, the information from the inertial sensors of the cameras 2.1, 2.2 can be used as training data to suitably adjust the weighting factors of the neural network.

The neural network 3 can be trained by training data, i.e. the weighting factors of the neural network 3 are adjusted by a training phase in such a way that the neural network 3 provides disparity information and/or distance information about the image information captured by the stereo camera system 2.

The training data (also referred to as ground-truth information) comprises pairs of images representing the same scene in each case with different positions and orientations of the cameras 2.1, 2.2. The training data also comprise distance information about each image pixel so that on the basis of the training data the error between the calculation result of the neural network 3 and the training data can be determined and the weighting factors of the neural network 3 are successively adjusted in such a way that the error is reduced.

In addition, the training data can include information regarding the ego-motion of the vehicle associated with the respective image pairs (i.e. ego-motion labeling) so that the neural network 3 learns during training how the image information of image pairs of an image sequence changes in time when the vehicle performs an ego-motion. The information about the ego-motion of the vehicle in the training data can preferably contain information about the translational motion of the vehicle along three spatial axes of a Cartesian coordinate system, i.e. in particular the longitudinal, vertical, and lateral velocities of the vehicle. In addition, the information about the ego-motion of the vehicle in the training data can contain information about the rotational motion of the vehicle about the three spatial axes of the Cartesian coordinate system, for example, the pitch, yaw, and roll velocity of the vehicle.

The neural network 3 comprises an output interface, as described above, at which information about the ego-motion of the vehicle is provided. During training, i.e. during the initial training or else re-training, i.e. post-training of the neural network 3, for example in the form of online training, this ego-motion information estimated by the neural network 3 is compared with the ego-motion information of the training data. The weighting factors of the neural network 3 are then adjusted in such a way that the error between the ego-motion information estimated by the neural network 3 and the ego-motion information of the training data is minimized.

The information about the ego-motion of the vehicle and/or the cameras 2.1, 2.2, contained in the training data, can be provided e.g. by the inertial sensors of the cameras 2.1, 2.2. Alternatively or additionally, movement information from an odometry unit of the vehicle can also be used.

The neural network 3 can, for example, be processed in a control unit of the stereo camera system 2. Alternatively, the neural network 3 can also be operated in a control unit that is provided separately from the stereo camera system 2.

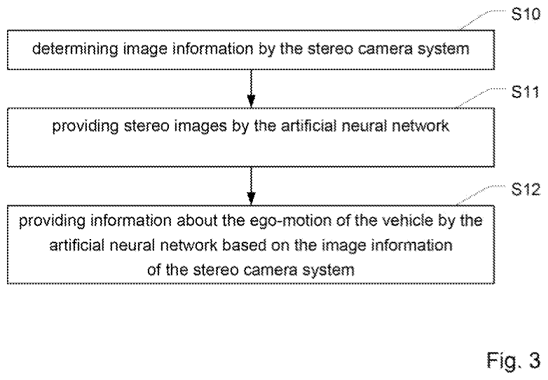

FIG. 3 shows a block diagram illustrating the steps of a method for determining the information about an ego-motion of a vehicle by means of a neural network.

First, image information is captured by the cameras 2.1, 2.2 of the stereo camera system 2 (S10). The image information comprise image pairs, the images of an image pair being captured at the same point in time, namely a first image by the first camera 2.1 and a second image by the second camera 2.2. A plurality of such image pairs are acquired in a temporary successive manner, so that an image sequence is obtained.

The neural network then determines stereo images of the area surrounding the vehicle (S11). In addition to pixel-related color values, these images also contain pixel-related distance information.

The neural network 3 also provides information about the ego-motion of the vehicle (S12). This information is determined on the basis of the image information of the stereo camera system, namely on the basis of the position change of areas of the scene represented in the image information over time. In particular, this may concern the changes in position of individual pixels or groups of pixels over time, which result from the ego-motion of the vehicle in space.

It is understood that numerous modifications as well as variations are possible without leaving the scope of protection defined by the claims.

### LIST OF REFERENCE SIGNS

1 system
2 stereo camera system
2.1, 2.2 camera
3 artificial neural network

1. A method for determining information about ego-motion of a vehicle, wherein the vehicle includes a stereo camera system with at least two cameras for capturing stereo images of an area surrounding the vehicle, and an artificial neural network for processing image information provided by the stereo camera system, wherein, during movement of the vehicle, the stereo camera system captures, by the at least two cameras, image sequences which contain a plurality of image information at different points in time, wherein the artificial neural network receives the image information and generates based on said image information stereo images with distance information, and wherein, based on the image information of the stereo camera system, the artificial neural network provides information regarding the ego-motion of the vehicle at an output interface.

2. The method according to claim 1, wherein the artificial neural network analyzes change of the image information over time in the image sequences and generates information regarding the ego-motion of the vehicle based on the change of image information.

3. The method according to claim 1, wherein the information regarding the ego-motion of the vehicle comprises information about translational motion of the vehicle along three axes of a Cartesian coordinate system.

4. The method according to claim 1, wherein the information regarding the ego-motion of the vehicle comprises information about a rotational motion of the vehicle about three axes of a Cartesian coordinate system.

5. The method according to claim 1, wherein the artificial neural network compensates for changes in calibration parameters of the stereo camera system.

6. The method according to claim 1, wherein the cameras of the stereo camera system comprise inertial sensors which determine changes in the movement of the cameras.

7. The method according to claim 6, wherein calibration parameters of the stereo camera system are adjusted by information provided by the inertial sensors of the cameras of the stereo camera system.

8. The method according to claim 1, wherein the artificial neural network is a pre-trained neural network which is trained by training data in the form of stereo images of a scene and associated calibration parameters, the training data indicating how the stereo images change depending on modifications of the calibration parameters of the cameras of the stereo camera system.

9. The method according to claim 1, wherein the artificial neural network is post-trained on the basis of calibration information generated from information of inertial sensors of the cameras.

10. A system for determining information about ego-motion of a vehicle, the vehicle comprising a stereo camera system with at least two cameras for capturing stereo images of an area surrounding the vehicle and an artificial neural network for processing image information provided by the stereo camera system, the stereo camera system being configured to capture image sequences containing a plurality of image information at different points in time by the at least two cameras during movement of the vehicle, wherein the artificial neural network is configured to receive the image information and generate based on the image information stereo images with distance information, and wherein the artificial neural network comprises an output interface at which information regarding the ego-motion of the vehicle is provided, which is calculated by the artificial neural network based on the image sequences.

11. The system according to claim 10, wherein the artificial neural network is configured to analyze change of the image information over time in the image sequences and to generate information regarding the ego-motion of the vehicle based on said change of image information.

12. The system according to claim 10, wherein the artificial neural network is configured to provide information about translational motion of the vehicle along three axes of a Cartesian coordinate system and information about a rotational motion of the vehicle about the three axes of the Cartesian coordinate system at the output interface.

13. The system according to claim 10, wherein the cameras of the stereo camera system comprise inertial sensors which are designed to determine changes in movement of the cameras.

14. The system according to claim 13, wherein the artificial neural network is post-trained on the basis of calibration information generated from information of the inertial sensors of the cameras.

15. A vehicle comprising a system according to claim 10.
